(19) United States
(12) Patent Application Publication
(10) Pub. No.: US 2014/0014772 A1
(43) Pub. Date: Jan. 16, 2014

(54) Jet mobil flying machine

(71) Applicant: Marva Lewis Boatman, Ruther Glen, VA (US)

(72) Inventor: Marva Lewis Boatman, Ruther Glen, VA (US)

(21) Appl. No.: 11/253,594

(22) Filed: Oct. 20, 2005

(51) Int. Cl. B64C 39/02

(52) U.S. Cl. CPC B64C 39/026
USPC 244/1 R

(57) ABSTRACT

The Jet Mobil Flying Machines designed to mobilize individual(s) through the air perhaps through hydraulic, digital mechanism that propels one into air space . . . flying. It has a concept of light weightiness, yet effective—able to fly/transport at an amusement park, landing center or for private usage. This is an invention design for amusement parks and future air travel. It consists of a new jet Mobil, specific handle (house the control mechanism), magnetic disc, and track. On the new jet Mobil flying machine the panel would include all in a unit that i.e. required to make it fly (laser unit), a magnetic port pad Would consist of a field of energy whereby when connected to track and immediate suction process is able to attract it to the landing disc . . . This design should include the lightest materials created to develop a smooth style and intelligently operating Jet Mobil flying machine to travel from one port to another . . .

The Jet Mobil Flying Machines is designed to mobilize individual(s) through the air perhaps through hydraulic, digital, laser mechanism that propels one into air space . . . flies. It has a concept of light weightiness, yet effective—able to fly/transport at an amusement park, landing center or for private usage. This is an invention design for amusement parks and future air travel. It consists of a Jet Mobil Flying Machine, specific handle (house the control mechanism), magnetic disc, and track. On the Jet Mobil Flying Machine the panel would include all in a unit that is required to make it fly (laser unit), a magnetic port pad would consist of a field of energy whereby when connected to track and immediate suction process is able to attract it to the landing disc . . . This design should include the lightest materials created to develop a smooth style and running Jet Mobil Flying Machine to travel from one port to another . . .

### CROSS REFERENCE TO RELATED APPLICATIONS

The Jet Mobil Flying Machine (JMFM) is design to identify mobilize individuals through air space through a hydraulic, digital or Advanced Technological mechanism running off solar energy and or magnetic energy . . . that propels one into the airspace . . . perfected with quality materials of the time of now, excluding liquid gas/substance.

### STATEMENT REGARDING FEDERALLY SPONSORED RESEARCH OR DEVELOPMENT

At this time there are no rights to my invention of the Jet Mobil Flying Machine made under federally sponsored research and development.

### REFERENCE TO SEQUENCE LISTING, A TABLE, OR COMPUTER PROGRAM LISTING COMPACT DISC APPENDIX

At this time there are no compact disc as a part of this project.

### BACKGROUND OF THE INVENTION

In July 1978 in Orlando, Fla. the concept of the Jet Mobil Flying Machine came to me creatively. I've attempted many times to start the patent process. It never seems to be the right time, as now it appears it is so!

I had recently graduated from Florida State University and was in the process of writing and perceived ideas by capturing them as they came to me! Now seems the appropriate time to patent, which was twenty-six years ago, and I'm soon to be 50 years old. Why wait any longer of newer concepts/ideas, when now is the time it's ready to be implemented along with some other possibilities. Hopefully somebody or society needs this product/idea and timing will be everything!

Space living, too . . . shouldn't we improve our earth living as well?

### BRIEF SUMMARY OF THE INVENTION

The idea of the jet mobil flying machine came to me in the year of 1978. I've always been a creative individual and now decide to share this info! Initially, I've gotten patent papers through the years and the latest was in 2003. Now is the time or never! Advantages of the invention are to able mankind to mobilize in another way, use in amusement parks and actually utilizes another level of air space to transport to other physical/special sites through a far lower level or airspace used by airplanes . . .

### BRIEF DESCRIPTION OF THE SEVERAL VIEWS OF THE DRAWINGS

FIG. 1A Front view of NJMFM-lever (brake)

FIG. 2A Side view-lever-magnetic disc

FIG. 3A Different view with another angle

FIG. 4A Digital Handle Control

FIG. 5A Magnetic Disc Magnetic pad

Under NJFM made under apparatus to be attracted to the landing disc pad

FIG. 6A Magnetic landing/parking track for NJMFM to land or depart on

### DETAILED DESCRIPTION OF THE INVENTION

The process of making this invention is to:
Alleviate some car congestion in urban areas
Play/amusement parks for fun/rural parks
The items patent that I researched weren't compatible in any way. No comparison to my idea/concept based on my researching. After researching there are no patents similar to mine. My research identified the following:
   U.S. Pat. No. 4,932,325A
   U.S. Pat. No. 4,813,634A
   U.S. Pat. No. 3,586,263A
Manufacturing would continue to provide jobs/improvement
This Idea would be an improvement of the first time air space is used to alleviate local/urban travel, physical car congestion/provide amusement in parks (Disney, Kings Dominion) or create separate flying entity locations. How about actual designed to be used in space travel too.

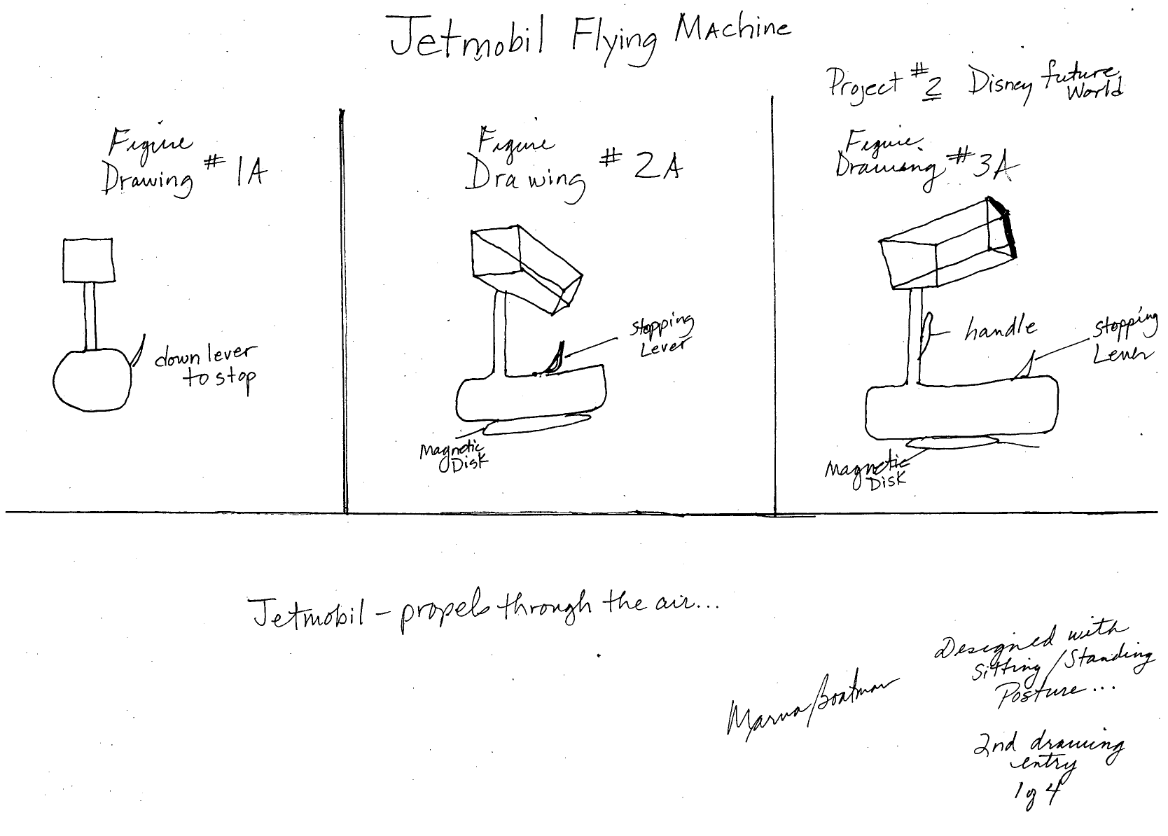

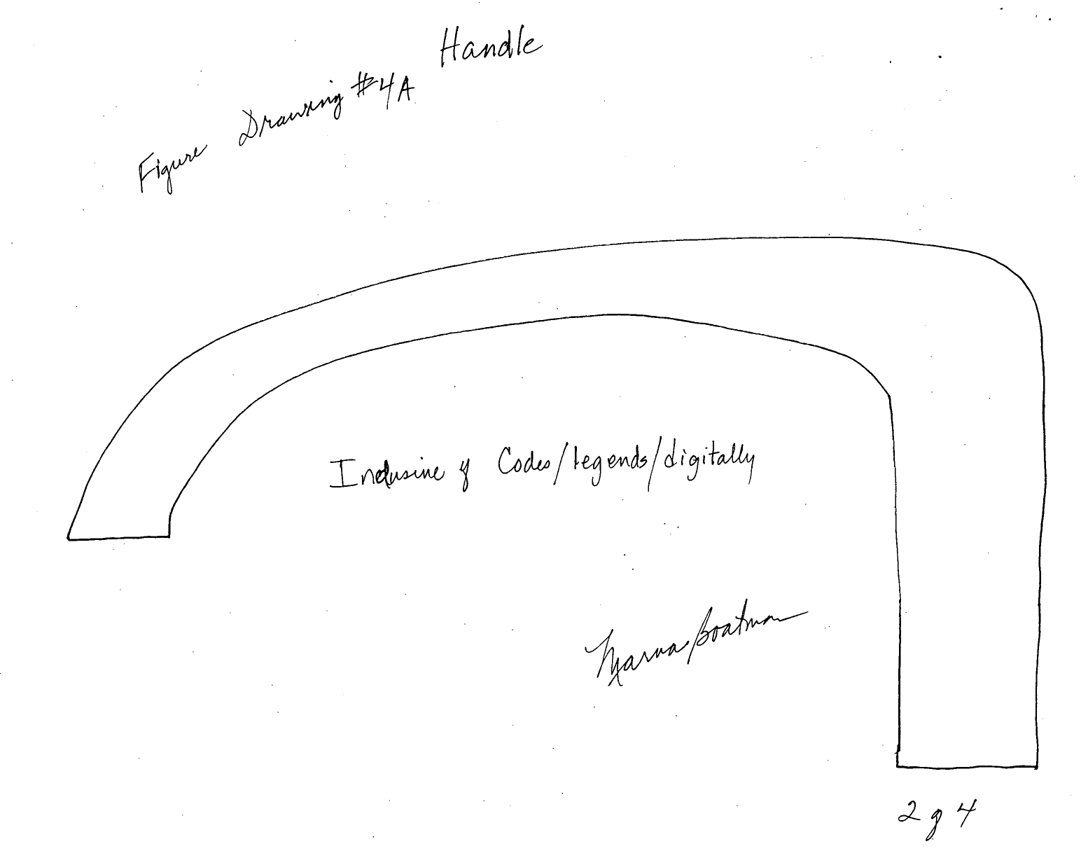

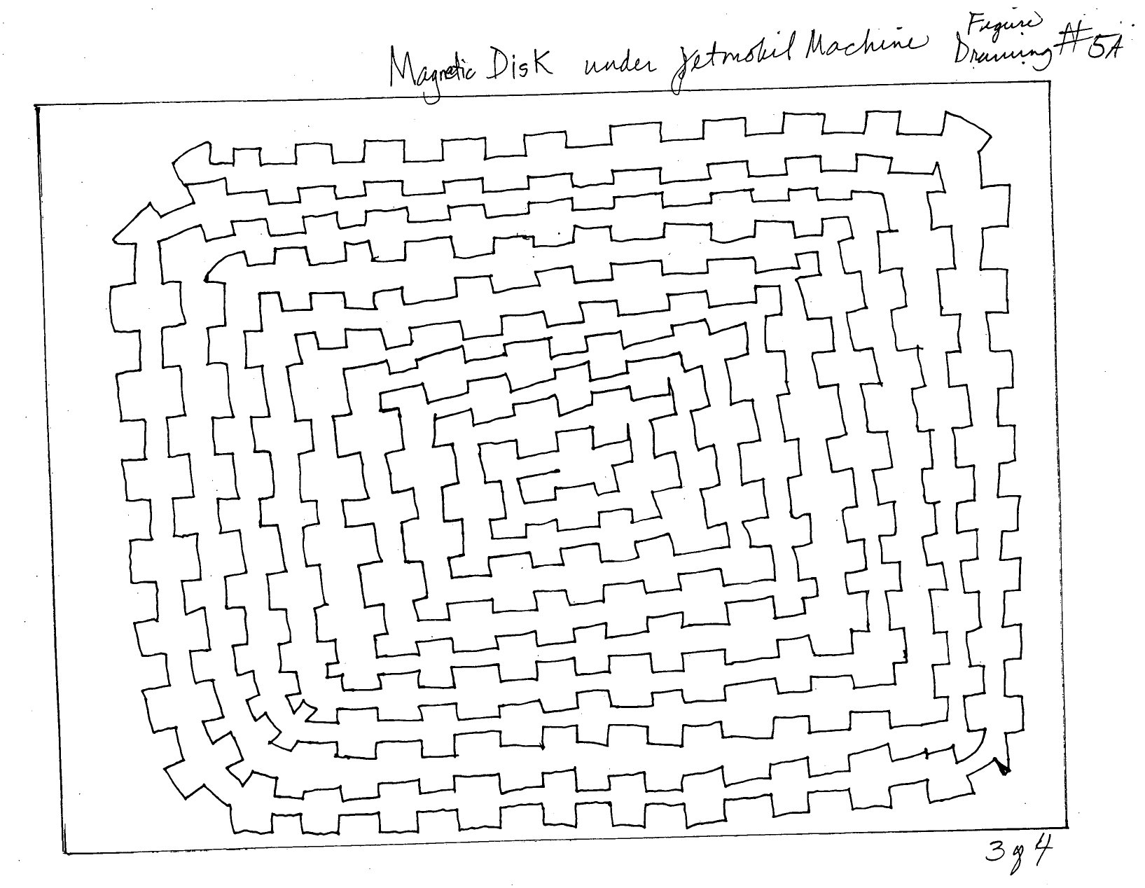

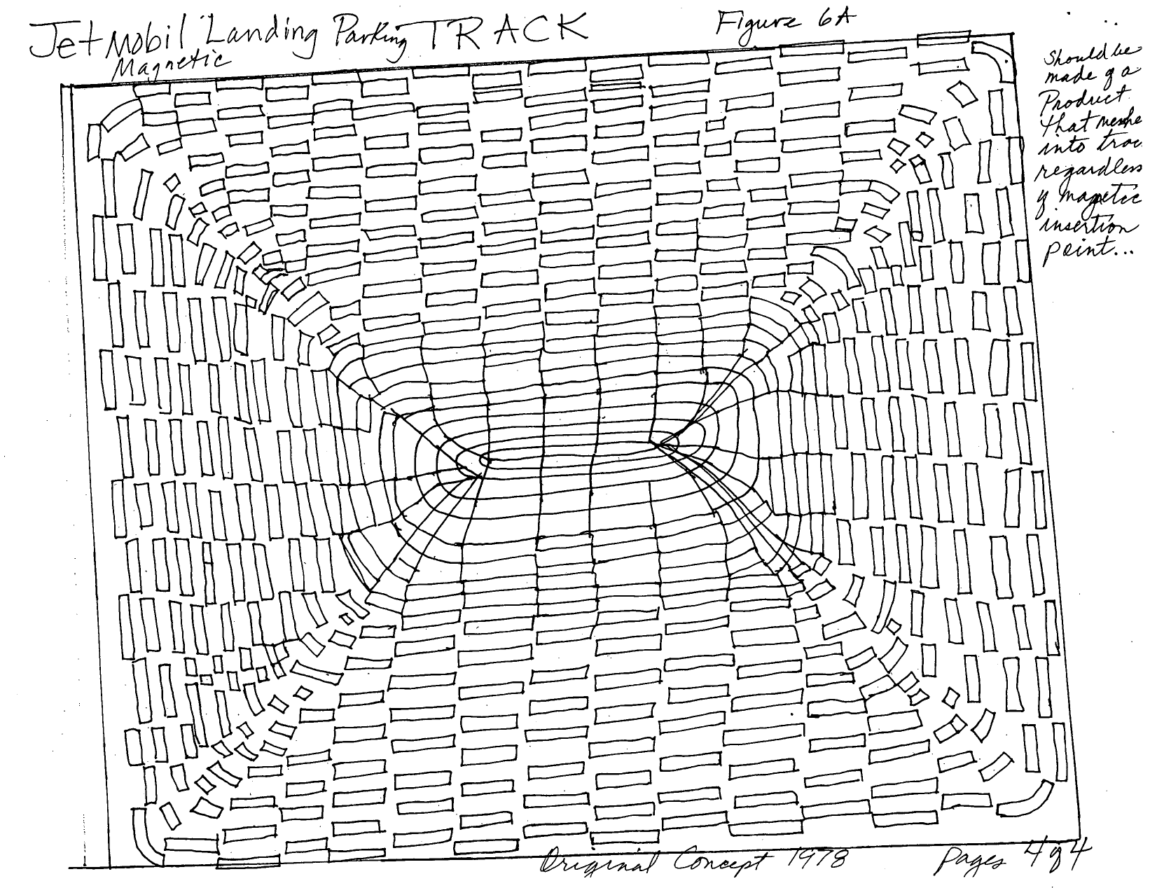

1. I claim the concept of the Jet Mobil Flying Machine originally perceived in July 1978 the idea, its control handle, magnetic disc, track pad, total object of description inclusive of FIG. 1A-6A. I claim all hydraulic, digital, technological, laser development towards the creation of the final product in name and spirit: I claim all rights to electronic processes, usage and development there of. I claim all rights to, the development, usage of this concept/ides said and unsaid. It is mine.
